(19) United States
(12) Patent Application Publication
(10) Pub. No.: US 2025/0050541 A1
(43) Pub. Date: Feb. 13, 2025

(54) PROCESSING METHOD FOR WORKPIECE

(71) Applicant: DISCO CORPORATION, Tokyo (JP)

(72) Inventor: Toru TANAKA, Tokyo (JP)

(21) Appl. No.: 18/784,200

(22) Filed: Jul. 25, 2024

(30) Foreign Application Priority Data
Aug. 10, 2023 (JP) 2023-131475

(51) Int. Cl. B28D 5/02; B28D 7/04

(52) U.S. Cl. CPC B28D 5/022; B28D 7/04

(57) ABSTRACT

There is provided a processing method for a workpiece to be applied when processing an outer peripheral portion of a disk-shaped workpiece having first and second circular sides. The processing method includes a cutting step being executed with an annular cutting blade including a first annular cutting edge portion and a second annular cutting edge portion that is less prone to consumption than the first annular cutting edge portion. The first annular cutting edge portion cut into a first region of the outer peripheral portion. The second annular cutting edge portion cut into a second region of the outer peripheral portion, the second region being located on an outer side, in a radial direction of the workpiece, of the first region.

### BACKGROUND OF THE INVENTION

### Field of the Invention

The present invention relates to a processing method for a workpiece.

### Description of the Related Art

In fabrication steps of semiconductor devices, a plurality of streets are set in a grid pattern on a front surface of a wafer, and devices such as integrated circuits (ICs) are formed in a plurality of respective regions defined by the streets. After this wafer is thinned to a predetermined thickness by being ground on a side of its back surface, for example, with a grinding machine or the like, the wafer is cut by a cutting machine or the like along the streets to be divided into the individual regions. A plurality of device chips are hence obtained, each including the device.

Keeping in step with the desire for high-integration device chips in recent years, development of stacked wafers, in each of which a plurality of wafers are three-dimensionally stacked, is under progress. For example, a through-silicon via (TSV) wafer, which is one kind of a stacked wafer, is formed by bonding together a plurality of silicon wafers each of which has a plurality of devices. Electrodes of devices in the individual silicon wafers are connected together by through-holes (vias) being formed in the individual silicon wafers and through electrodes being provided inside the through-holes (vias).

In fabrication steps of such a stacked wafer, after a first wafer is bonded at one side thereof with a second wafer, for example, the first wafer is ground at the other side thereof by a grinding machine or the like, and is thus thinned to a predetermined thickness. On an outer peripheral portion of the first wafer, a chamfered portion rounded by removal of corners of the outer peripheral portion is generally formed to enhance its mechanical strength.

When the first wafer is thinned by grinding, the chamfered portion (outer peripheral portion) of the first wafer is processed into a thin and sharp shape (knife edge shape). This however leads to a reduction in the mechanical strength of the outer peripheral portion of the first wafer, so that chipping is prone to occur at the processed outer peripheral portion of the first wafer. If this chipping reaches devices, the devices are damaged.

As a countermeasure for this problem, a technique called “edge trimming” that removes the chamfered portion by cutting the outer peripheral portion of the wafer with a cutting blade is known (see, for example, Japanese Patent Laid-open No. 2007-158239). If the outer peripheral portion of the wafer is processed with the cutting blade, however, such a phenomenon (uneven wear) that portions of a tip of the cutting blade are worn out earlier than the remaining portions of the tip occurs.

If the wafer is cut with the cutting blade unevenly worn out at the tip thereof, there is a problem that the wafer cannot be cut appropriately. Before cutting the wafer, dressing work is hence performed to straighten up the tip of the cutting blade into a planar shape with use of a dresser board (see, for example, Japanese Patent Laid-open No. 2010-000588).

### SUMMARY OF THE INVENTION

However, the above-mentioned dressing work of the cutting blade increases the time and cost practically required for the production of wafers. There has hence been a desire for a processing method for a workpiece, in which a cutting blade is less likely to undergo an uneven wear so that dressing work is lightened as much as possible.

The present invention therefore has as an object thereof the provision of a processing method for a workpiece, in which a cutting blade is less likely to undergo an uneven wear when removing an outer peripheral portion of a wafer by the cutting blade.

In accordance with an aspect of the present invention, there is provided a processing method for a disk-shaped workpiece having a first circular side and a second circular side. The processing method is to be applied when processing an outer peripheral portion of the workpiece, and includes a holding step of holding the workpiece at the second circular side thereof such that the workpiece is exposed at the first circular side thereof, and a cutting step of, after the holding step, with an annular cutting blade including a first annular cutting edge portion and a second annular cutting edge portion that is less prone to consumption than the first annular cutting edge portion kept rotating, allowing the first annular cutting edge portion to cut into a first region of the outer peripheral portion and also allowing the second annular cutting edge portion to cut into a second region of the outer peripheral portion, the second region being located on an outer side, in a radial direction of the workpiece, of the first region, and moving the cutting blade relative to and along the outer peripheral portion of the workpiece, whereby the outer peripheral portion of the workpiece is cut.

Preferably, the cutting blade may further include a third annular cutting edge portion that is more prone to consumption than the first annular cutting edge portion.

Preferably, the cutting blade has a stacked structure in which the first annular cutting edge portion, the second annular cutting edge portion, and the third annular cutting edge portion are stacked such that the second annular cutting edge portion is in contact with the first annular cutting edge portion and the third annular cutting edge portion is in contact with the second annular cutting edge portion, and in the cutting step, the third annular cutting edge portion is arranged in a third region located on an outer side, in the radial direction, of the outer peripheral portion.

Preferably, the third annular cutting edge portion contains a binder, but not abrasive grains.

Preferably, the workpiece is a bonded wafer obtained by bonding, with a second wafer, a first wafer chamfered at an outer peripheral portion thereof, and, in the cutting step, the cutting blade is allowed to cut into the bonded wafer from the first circular side, where the first wafer is arranged, to a position that does not reach the second circular side.

Preferably, the first annular cutting edge portion and the second annular cutting edge portion both contain abrasive grains and a binder, and the abrasive grains contained in the second annular cutting edge portion are greater in grain size than the abrasive grains contained in the first annular cutting edge portion, the abrasive grains contained in the second annular cutting edge portion are higher in concentration than the abrasive grains contained in the first annular cutting edge portion, or the binder contained in the second annular cutting edge portion is higher in hardness than the binder contained in the first annular cutting edge portion.

In the processing method according to the aspect of the present invention for the workpiece, the cutting blade having the first annular cutting edge portion (hereinafter simply referred to as the “first cutting edge portion”) and the second annular cutting edge portion (hereinafter simply referred to as the “second cutting edge portion”) that is less prone to consumption than the first cutting edge portion is used. Further, the first cutting edge portion is allowed to cut into the first region located on an inner side in the outer peripheral portion of the workpiece, and the second cutting edge portion is also allowed to cut into the second region located on the outer side in the outer peripheral portion of the workpiece.

With a cutting blade having a single cutting edge portion, an outer portion of the cutting blade, which processes the second region on the outer side of the outer peripheral portion, is generally more prone to consumption compared with an inner portion of the cutting blade, which processes the first region on the inner side of the outer peripheral portion. By allowing the second cutting edge portion, which is relatively less prone to consumption, to cut into this second region, a difference is hence less likely to arise between the extent of consumption of the first cutting edge portion and the extent of consumption of the second cutting edge portion, thereby suppressing the uneven wear of the cutting blade. According to the processing method of the aspect of the present invention for the workpiece, the cutting blade is less likely to undergo an uneven wear as described above.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a workpiece;

FIG. 2 is a side view of the workpiece of FIG. 1;

FIG. 3 is a perspective view of the workpiece of FIG. 1 supported on a frame via a sheet;

FIG. 4 is a perspective view depicting a cutting machine as a processing machine to be used in a processing method according to an embodiment of the present invention for the workpiece;

FIG. 5 is a perspective view of a cutting blade of the cutting machine of FIG. 4;

FIG. 6 is a fragmentary side view of a cutting edge of the cutting blade as seen in a direction perpendicular to its thickness direction in FIG. 5;

FIG. 7 is a flow diagram of the processing method according to the embodiment;

FIG. 8 is a fragmentary side view depicting the workpiece, the cutting edge, etc., in a cutting step of the processing method according to the embodiment;

FIG. 9 is a perspective view of a stacked wafer as another workpiece;

FIG. 10 is a side view of the stacked wafer of FIG. 9;

FIG. 11 is a fragmentary side view of a cutting edge to be used in a processing method according to a first modification of the embodiment for the workpiece, as seen in a direction perpendicular to its thickness direction;

FIG. 12 is a fragmentary side view depicting the workpiece of FIG. 2, the cutting edge of FIG. 11, etc., in a cutting step of the processing method according to the first modification;

FIG. 13 is a fragmentary side view depicting the workpiece of FIG. 2, the cutting edge of FIGS. 11 and 12, etc., in a cutting step of a processing method according to a second modification of the embodiment for the workpiece; and

FIG. 14 is a fragmentary side view depicting the workpiece of FIGS. 9 and 10, the cutting edge of FIGS. 11 to 13, etc., in a cutting step of a processing method according to a third modification of the embodiment for the workpiece.

### DETAILED DESCRIPTION OF THE PREFERRED EMBODIMENT

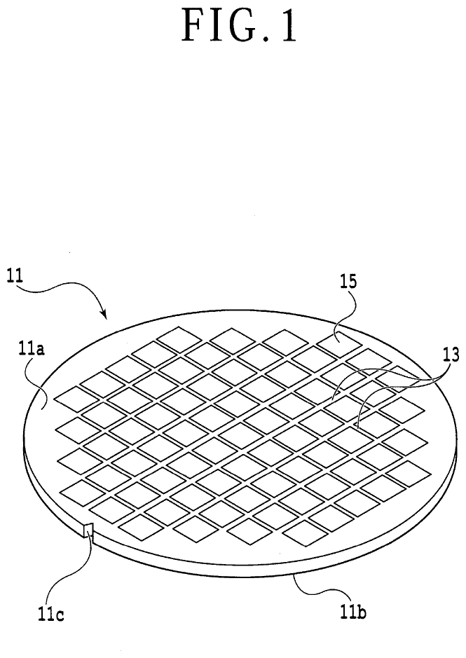

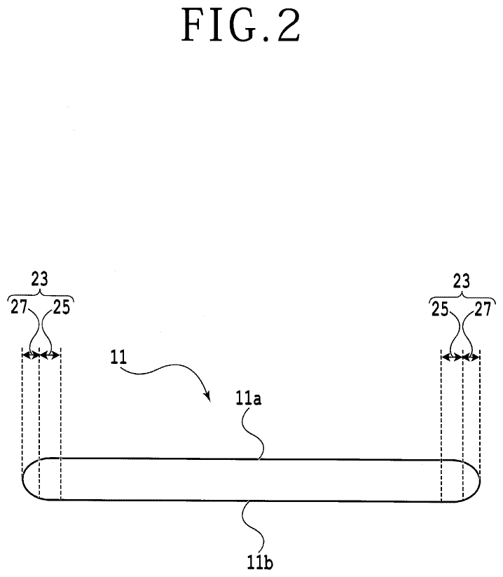

With reference to FIGS. 1 through 10 of the attached drawings, a description will hereinafter be made of an embodiment of the present invention. A description will first be made of a workpiece to be used in a processing method according to this embodiment for the workpiece. FIG. 1 is a perspective view of the workpiece, and FIG. 2 is a side view of the workpiece of FIG. 1.

As depicted in FIG. 1, a workpiece 11 is, for example, a disk-shaped wafer made from a semiconductor material such as silicon. Described specifically, the workpiece 11 is formed in a substantially disk shape, which has a substantially circular first side 11a (hereinafter simply referred to as the “first side 11a”), and a substantially circular second side 11b (hereinafter simply referred to as the “second side 11b”) on an opposite side of the first side 11a. In a portion of an outer peripheral portion (peripheral edge portion) of the workpiece 11, a notch 11c is formed to indicate a crystal orientation of the workpiece 11.

The workpiece 11 has a diameter (a width of the first side 11a or the second side 11b) of, for example, 100 mm or greater but 450 mm or smaller, typically 300 mm. The workpiece 11 has a thickness of, for example, 100 μm or greater but 10,000 μm or smaller, typically 775 μm. It is to be noted that the material, shape, diameter (width of the first side 11a or the second side 11b), and thickness of the workpiece 11 are not limited to those exemplified above. Further, an orientation flat may be formed instead of the notch 11c on the workpiece 11. Furthermore, neither the notch 11c nor the orientation flat may be formed in or on the workpiece 11.

On the first side 11a of the workpiece 11, a plurality of straight streets 13 of a predetermined width are set in a grid pattern. The first side 11a of the workpiece 11 is defined into a plurality of regions by the streets 13, and devices 15 such as ICs are disposed in the respective regions.

As depicted in FIG. 2, on the workpiece 11, a chamfered portion 23 rounded by removal of corners of the outer peripheral portion of the workpiece 11 is formed in an annular shape along an outer periphery of the workpiece 11. The chamfered portion 23 includes a first region 25 and a second region 27 located on an outer side, in a radial direction of the workpiece 11, of the first region 25.

Hence, the width of the chamfered portion 23 (the length along the radial direction of the workpiece 11) is represented by the sum of the width of the first region 25 and the width of the second region 27. The width of the chamfered portion 23 is 0.5 mm or greater but 5 mm or smaller.

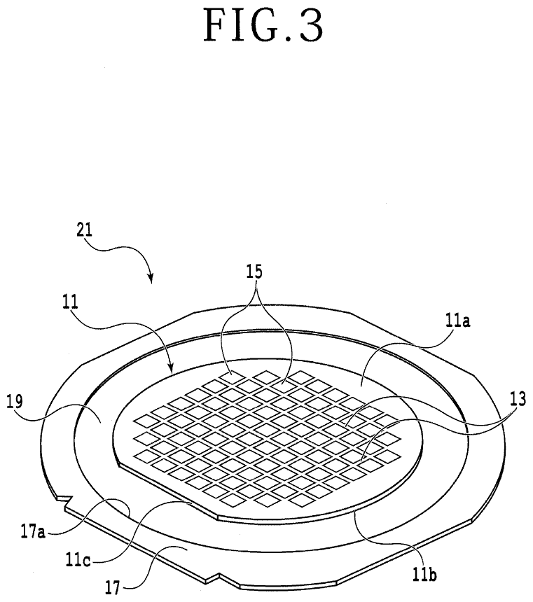

FIG. 3 is a perspective view of the workpiece of FIG. 1 supported on a frame via a sheet. At the time of being processed, the workpiece 11 is supported on an annular frame 17 via a circular sheet 19 for convenience in handling (transfer, holding, and the like) of the workpiece 11. The frame 17 is made, for example, from metal such as stainless steel (SUS), and has, in a central portion thereof, a circular opening 17a extending in a thickness direction through the frame 17. It is to be noted that the diameter of the opening 17a is greater than the diameter of the workpiece 11 (the width of the first side 11a or the second side 11b).

On the workpiece 11 and the frame 17, the circular sheet 19 is fixed. The sheet 19 is, for example, a tape including a film-shaped base material and a self-adhesive layer (glue layer) disposed on the base material. The base material is formed with resin such as polyolefin, polyvinyl chloride, or polyethylene terephthalate, and the self-adhesive layer is formed with an epoxy, acrylic, or rubbery self-adhesive, or the like. It is to be noted that the self-adhesive layer may also be formed with ultraviolet (UV)-curable resin which is cured by exposure to ultraviolet light.

With the workpiece 11 arranged inside of the opening 17a of the frame 17, the sheet 19 is bonded at the central portion thereof to the second side 11b of the workpiece 11, and is also bonded at an outer peripheral portion thereof to the frame 17. As a consequence, a substrate unit (frame unit) 21 is constituted, in which the workpiece 11 is supported on the frame 17 via the sheet 19 and the workpiece 11, frame 17, and sheet 19 are integrated together. However, the workpiece 11 may not necessarily be supported on the frame 17.

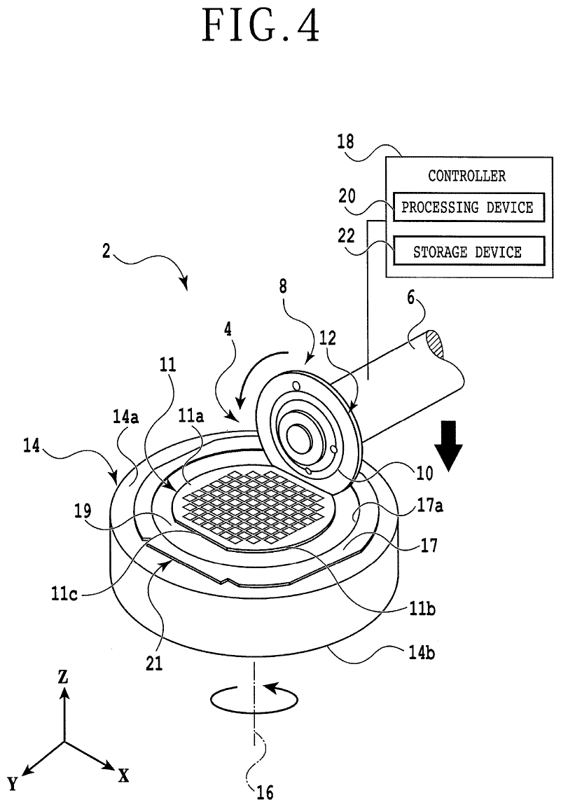

Next, a description will be made of a processing machine (cutting machine) that processes the above-mentioned workpiece 11. FIG. 4 is a perspective view depicting the cutting machine as the processing machine to be used in the processing method according to this embodiment. As depicted in FIG. 4, a cutting machine 2 has a chuck table 14.

The chuck table 14 is configured in a substantially disk shape, which has a substantially circular first surface 14a and a substantially circular second surface 14b on an opposite side of the first surface 14a. The chuck table 14 has a diameter (width of the first surface 14a or the second surface 14b) that is slightly greater than the workpiece 11 to support the workpiece 11 in its entirety from below. Described specifically, the diameter (width) of the first surface 14a is greater by a range of 20 mm or greater and 200 mm or smaller than the diameter (width) of the workpiece 11.

The first surface 14a of the chuck table 14 is configured by a porous body at a portion thereof. The porous body is formed in a porous structure, for example, by using ceramics such as alumina (Al₂O₃) or silica (SiO₂).

A through-hole (not depicted) is disposed inside the chuck table 14. The through-hole is connected at one end thereof to the porous body disposed on a side of the first surface 14a, and is connected at the other end thereof to a suction source (not depicted). By operating the suction source with the workpiece 11 kept in contact with the first surface 14a of the chuck table 14, a negative pressure that is generated from the suction source acts on the first surface 14a via the through-hole and pores in the porous body, whereby the workpiece 11 is drawn to the first surface 14a. That is, the workpiece is held by suction on the chuck table 14.

The chuck table 14 is connected to a rotary drive source (not depicted) such as a motor. By a rotary drive force received from the rotary drive source, the chuck table 14 is rotated about an axis 16 of rotation that is substantially perpendicular to the first surface 14a.

Further, the chuck table 14 is supported, along with the rotary drive source connected to the chuck table 14, by a chuck table moving mechanism (processing feed mechanism) (not depicted) of the ball screw type that includes a ball screw to convert the rotary drive force of the motor or the like into a linear drive force. By the linear drive force of this chuck table moving mechanism, the chuck table 14 is moved along a first direction (a direction along an X-axis in FIG. 4), which is substantially parallel to the first surface 14a of the chuck table 14.

The cutting machine 2 has a cutting unit 4. The cutting unit 4 includes a spindle 6. On one end portion (distal end portion) of the spindle 6, a cutting blade 8 is fitted. On the other end portion (proximal end portion) of the spindle 6, a motor (not depicted) is connected. The spindle 6 is rotated by a rotary drive force received from the motor.

The cutting unit 4 is supported by a cutting unit moving mechanism (indexing feed mechanism, cutting-in feed mechanism) (not depicted) of the ball screw type that includes two sets of ball screws to convert the rotary drive force of the motor or the like into a linear drive force. By the linear drive force of this cutting unit moving mechanism, the cutting unit 4 is moved along a second direction (a direction along a Y-axis in FIG. 4), which is substantially perpendicular to the first direction, and a third direction (a direction along a Z-axis in FIG. 4), which is substantially perpendicular to the first direction and second direction.

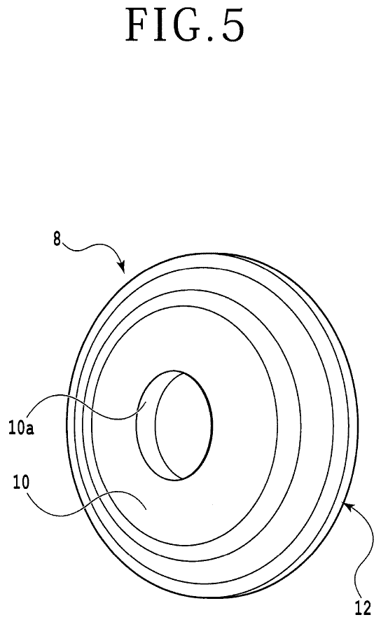

FIG. 5 is a perspective view of the cutting blade 8. A depicted in FIG. 5, the cutting blade 8 has an annular hub 10 made from metal such as SUS and an annular cutting edge 12 disposed on a peripheral edge portion of the annular hub 10. The hub 10 has, at a central portion thereof, a hole 10a through which the spindle 6 is inserted. The cutting edge 12 has been formed, for example, by dispersing and fixing abrasive grains of diamond or the like with a binder made of resin, metal, or the like, and is formed with a thickness of 30 μm or greater but 5 mm or smaller, typically 3 mm.

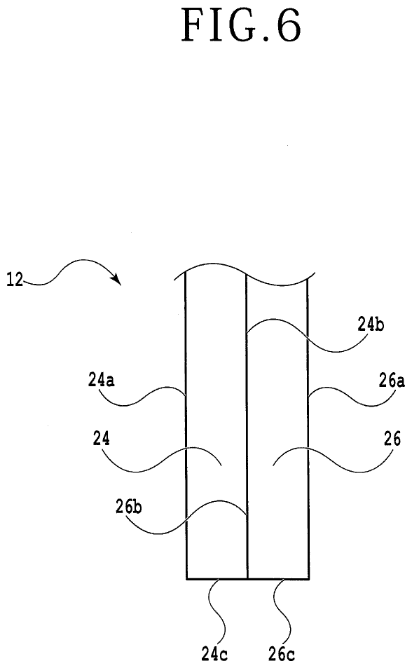

FIG. 6 is a fragmentary side view of a portion (a tip portion remote from the hub 10) of the cutting edge 12 as seen in a direction perpendicular to its thickness direction in FIG. 5. As depicted in FIG. 6, the cutting edge 12 has a structure in which a first annular cutting edge portion 24 (hereinafter simply referred to as the “first cutting edge portion 24”) and a second annular cutting edge portion 26 (hereinafter simply referred to as the “second cutting edge portion 26”) are stacked in the thickness direction.

The first cutting edge portion 24 has a first surface 24a substantially parallel to a radial direction of the first cutting edge portion 24 and directed toward an outside of the cutting edge 12, a second surface 24b substantially parallel to the first surface 24a and directed toward an inside of the cutting edge 12, and a third surface 24c that is connected to outer peripheral edges of the first surface 24a and the second surface 24b and that constitutes a tip of the first cutting edge portion 24.

Similarly, the second cutting edge portion 26 has a first surface 26a substantially parallel to a radial direction of the second cutting edge portion 26 and directed toward the outside of the cutting edge 12, a second surface 26b substantially parallel to the first surface 26a and directed toward the inside of the cutting edge 12, and a third surface 26c that is connected to outer peripheral edges of the first surface 26a and the second surface 26b and that constitutes a tip of the second cutting edge portion 26. It is to be noted that, in this embodiment, the second surface 24b of the first cutting edge portion 24 and the second surface 26b of the second cutting edge portion 26 are in close contact with each other.

The first cutting edge portion 24 has a thickness equal to or greater than the width (the length in the radial direction) of the first region 25 such that, when allowed to cut into the workpiece 11, the first cutting edge portion 24 can cut into the entirety of the first region 25 in the radial direction of the workpiece 11.

Similarly, the second cutting edge portion 26 has a thickness equal to or greater than the width (the length in the radial direction) of the second region 27 such that, when allowed to cut into the workpiece 11, the second cutting edge portion 26 can cut into the entirety of the second region 27 in the radial direction of the workpiece 11.

The second cutting edge portion 26 is configured to be less prone to consumption than the first cutting edge portion 24. In other words, the first cutting edge portion 24 is more prone to consumption than the second cutting edge portion 26. Described specifically, the second cutting edge portion 26 is smaller in consumption loss (wear loss) than the first cutting edge portion 24 when the same object is cut under the same processing conditions by each of the first cutting edge portion 24 and the second cutting edge portion 26.

In a configuration that the abrasive grains in the second cutting edge portion 26 are greater in average grain size than the abrasive grains in the first cutting edge portion 24, for example, the second cutting edge portion 26 is less prone to consumption than the first cutting edge portion 24. Described specifically, if the average grain size of the abrasive grains in the first cutting edge portion 24 is assumed to be 1, the average grain size of the abrasive grains in the second cutting edge portion 26 is greater than 1 but smaller than 3. In other words, the average grain size of the abrasive grains in the second cutting edge portion 26 is greater than 1 times but smaller than 3 times the average grain size of the abrasive grains in the first cutting edge portion 24. The specific average grain sizes of their abrasive grains are adjusted by also taking the material of the workpiece, the required quality of processing, and the like into consideration.

It is to be noted that the term “average grain size” typically means a grain diameter (median diameter, d50 diameter, 50% diameter) at a cumulative value of 50% in a particle diameter distribution measured by the laser diffraction scattering method. In this embodiment, however, an average grain size may be calculated by a desired calculation method insofar as a comparison can be made between the first cutting edge portion 24 and the second cutting edge portion 26. As an average grain size, use may also be made, for example, of the average value of grain diameters as obtained by calculating and averaging the grain diameters of a plurality of abrasive grains from an image acquired by observation under electron microscope.

Further, in a configuration that the abrasive grains in the second cutting edge portion 26 is higher in concentration than the abrasive grains in the first cutting edge portion 24, the second cutting edge portion 26 is less prone to consumption than the first cutting edge portion 24. Here, the concentration of the abrasive grains in the first cutting edge portion 24 means the volume (specifically, vol %) of the abrasive grains contained per cm³ of the volume of the first cutting edge portion 24. Similarly, the concentration of the abrasive grains in the second cutting edge portion 26 means the volume (specifically, vol %) of the abrasive grains contained per cm³ of the volume of the second cutting edge portion 26.

Described specifically, if the concentration of the abrasive grains in the first cutting edge portion 24 is assumed to be 1, the concentration of the abrasive grains in the second cutting edge portion 26 is higher than 1 but equal to or lower than 20. In other words, the concentration of the abrasive grains in the second cutting edge portion 26 is higher than 1 times but equal to or lower than 20 times the concentration of the abrasive grains in the first cutting edge portion 24. The specific concentrations of abrasive grains are adjusted by also taking the material of the workpiece, the required quality of processing, and the like into consideration.

Further, in a configuration that the binder in the second cutting edge portion 26 is higher in hardness than the binder in the first cutting edge portion 24, the second cutting edge portion 26 is also less prone to consumption than the first cutting edge portion 24. Their hardness values are evaluated, for example, in terms of Vickers hardness (HV), Rockwell hardness (HR), or Brinell hardness (HB), and are each measured by a commercial hardness tester. Specific Vickers hardness values are adjusted by also taking the material of the workpiece, the required quality of processing, and the like into consideration.

The cutting machine 2 also has one or more transfer mechanisms (not depicted) that can transfer the above-mentioned workpiece 11 to the chuck table 14 or the like.

Each transfer mechanism is, for example, a robot arm. By the transfer mechanism or mechanisms, the workpiece 11 is loaded onto the first surface 14a of the chuck table 14 such that the workpiece 11 is exposed on the side of the first side 11a. By the transfer mechanism or mechanisms, the workpiece 11 is also unloaded from the first surface 14a of the chuck table 14 to an outside of the chuck table 14.

To various elements of the above-mentioned cutting machine 2, a controller 18 (see FIG. 4) is connected.

Operation of each element is controlled by this controller 18. The controller 18 is configured by a computer, which includes, for example, a processing device 20 (see FIG. 4), such as a central processing unit (CPU), and a storage device 22 (see FIG. 4) constructed of a main storage device such as a dynamic random access memory (DRAM) and/or an auxiliary storage device such as a hard disk drive or a flash memory.

The processing device 20 operates in accordance with programs (software) stored in the storage device 22, whereby functions of the controller 18 are realized. Yet, the controller 18 may be realized by hardware alone. It is to be noted that more specific functions of this controller 18 will be explained in the following description on the processing method of this embodiment.

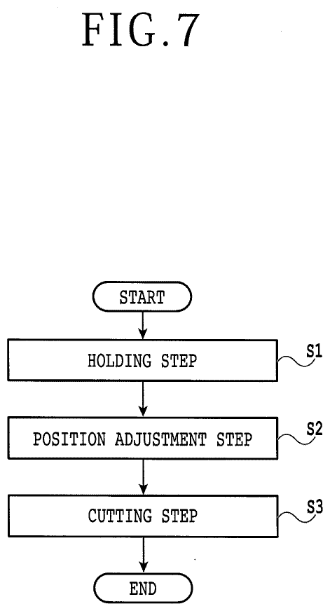

Next, the processing method according to this embodiment will be described. FIG. 7 is a flow diagram of the processing method according to this embodiment. As illustrated in FIG. 7, the processing method according to this embodiment includes a holding step S1, a position adjustment step S2, and a cutting step S3. It is to be noted that, in this embodiment, the individual steps which make up the processing method are performed based on instructions from the controller 18.

In the holding step S1, the workpiece 11 is held on the first surface 14a of the chuck table 14. Described specifically, by the above-mentioned transfer mechanism or mechanisms, for example, the workpiece 11 is loaded from an outside of the cutting machine 2 to the chuck table 14, and is placed on the first surface 14a of the chuck table 14. As mentioned above, in this embodiment, the second side 11b of the workpiece 11 is placed on the first surface 14a of the chuck table 14 such that the first side 11a of the workpiece 11 is exposed.

When the negative pressure of the suction source is then allowed to act on the first surface 14a under control by the controller 18, the workpiece 11 is drawn to the first surface 14a of the chuck table 14. That is, the workpiece 11 is held on the first surface 14a of the chuck table 14. It is to be noted that the workpiece 11 may also be placed on the first surface 14a of the chuck table 14 manually by an operator or the like.

Next, the position adjustment step S2 is performed. In the position adjustment step S2, the relation in position between the cutting blade 8 of the cutting unit 4 and the workpiece 11 held on the chuck table 14 is adjusted in the first direction (the direction along the X-axis) and the second direction (the direction along the Y-axis).

Typically, the relation in position between the cutting blade 8 and the workpiece 11 is adjusted such that a lower end of the first cutting edge portion 24 of the cutting blade 8 is positioned right above the first region 25 of the chamfered portion 23 of the workpiece 11. In addition, the relation in position between the cutting blade 8 and the workpiece 11 is also adjusted such that a lower end of the second cutting edge portion 26 of the cutting blade 8 is positioned right above the second region 27 of the chamfered portion 23 of the workpiece 11. In other words, in order to realize such positional relations, the position in the first direction of the chuck table 14 is adjusted by the chuck table moving mechanism, and the position in the second direction of the cutting unit 4 is adjusted by the cutting unit moving mechanism.

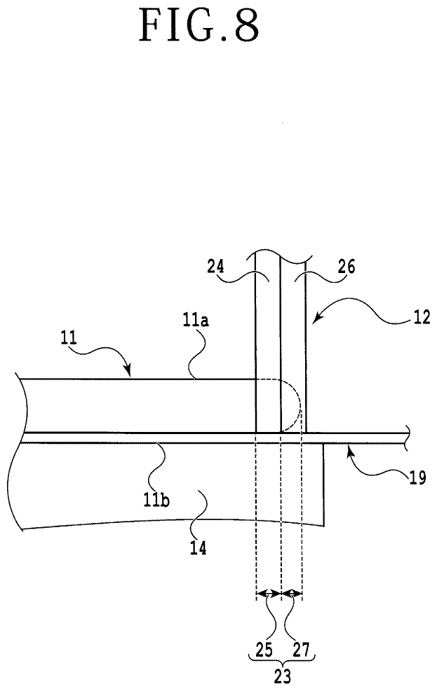

Next, the cutting step S3 is performed. FIG. 8 is a fragmentary side view depicting the workpiece 11, the cutting edge 12, etc., in the cutting step S3 of the processing method according to this embodiment. In the cutting step S3, with the cutting blade 8 kept rotating, the cutting blade 8 and the workpiece 11 are moved relative to each other along the third direction (the direction along the Z-axis). Described specifically, with the spindle 6 kept rotating by the motor, the cutting unit moving mechanism lowers the cutting unit 4 along the third direction.

In addition, the workpiece 11 held on the chuck table 14 is rotated while the cutting unit 4 is being lowered by the cutting unit moving mechanism. In other words, the rotary drive source connected to the chuck table 14 rotates the chuck table 14 about the axis 16 of rotation concurrently with the lowering of the cutting blade 8.

By the chuck table 14 being rotated about the axis 16 of rotation while the cutting blade 8 being lowered as mentioned above, the cutting blade 8 is allowed to cut into the entirety of the chamfered portion 23 disposed on the outer peripheral portion of the workpiece 11. The chamfered portion 23 of the workpiece 11 is hence cut and removed by the cutting blade 8.

In this embodiment, the cutting blade 8 is lowered to a depth at which the cutting blade 8 is allowed to cut slightly into the sheet 19. If the thickness of the workpiece 11 is 775 μm, for example, the cut-in depth of the cutting blade 8 is set to 800 μm. Further, the rotational speeds of the spindle 6 and the chuck table 14 are set to 30,000 rpm and 72 deg/s, respectively, in this embodiment. However, cutting conditions are not limited to those exemplified above, and are appropriately set according to the material and thickness of the workpiece 11.

After the chamfered portion 23 of the workpiece 11 has completely been removed, the series of steps of the processing method according to this embodiment are ended. A dashed line portion in FIG. 8 indicates the portion cut and removed by the cutting blade 8 (in other words, the chamfered portion 23 of the workpiece 11).

In the processing method according to this embodiment, the cutting blade 8 having the first cutting edge portion 24 and the second cutting edge portion 26, which is less prone to consumption than the first cutting edge portion 24, is used as described above. The first cutting edge portion 24 is allowed to cut into the first region 25 located on an inner side in the outer peripheral portion of the workpiece 11, while the second cutting edge portion 26 is allowed to cut into the second region 27 located on an outer side in the outer peripheral portion of the workpiece 11.

With a cutting blade having a single cutting edge portion, an outer portion of the cutting blade, which processes the second region on the outer side, is generally more prone to consumption compared with an inner portion of the cutting blade, which processes the first region on the inner side. By allowing the second cutting edge portion, which is relatively less prone to consumption, to cut into this second region, a difference is hence less likely to arise between the extent of consumption of the first cutting edge portion and the extent of consumption of the second cutting edge portion, thereby suppressing the uneven wear of the cutting blade. The frequency of dressing work is reduced accordingly.

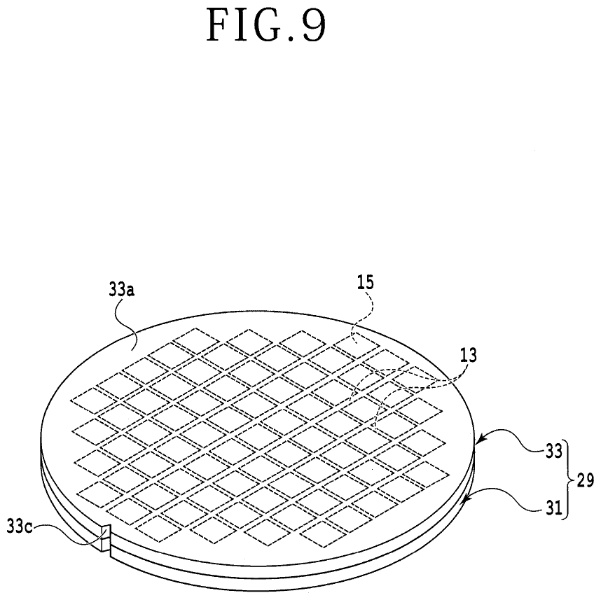

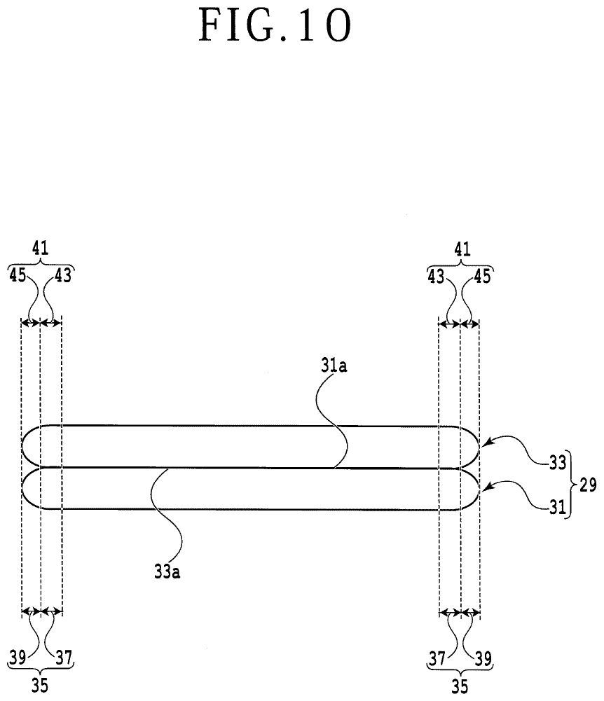

It is to be noted that the processing method according to this embodiment can also be used when processing a stacked wafer including a plurality of wafers bonded together. FIG. 9 is a perspective view of a stacked wafer as another workpiece, and FIG. 10 is a side view of the stacked wafer of FIG. 9. As depicted in FIGS. 9 and 10, a workpiece 29 as the stacked wafer is configured by a first wafer 31 and a second wafer 33 stacked together.

The first and second wafers 31 and 33 are similar in size and material to the workpiece 11. As in the workpiece 11, streets 13 and devices 15 are also formed on a first side 31a of the first wafer 31 and a first side 33a of the second wafer 33. Yet, the streets 13 and the devices 15 may be formed on only one of the first wafer 31 or the second wafer 33. Further, the streets 13 and the devices 5 may be formed on neither the first wafer 31 nor the second wafer 33.

For example, the first wafer 31 and the second wafer 33, which make up the workpiece 29, are joined together by heating the first wafer 31 and the second wafer 33, with these wafers 31 and 33 kept in contact with each other, and allowing elements, which are contained in the first wafer 31 and the second wafer 33, respectively, to mutually diffuse.

As an alternative, the first wafer 31 and the second wafer 33 are joined together, for example, by applying an adhesive to one of the first wafer 31 or the second wafer 33, and bonding the first wafer 31 and the second wafer 33 via the adhesive.

As depicted in FIG. 10, on the first wafer 31, a chamfered portion 35 rounded by removal of corners of an outer peripheral portion of the first wafer 31 is formed in an annular shape along an outer periphery of the first wafer 31. The chamfered portion 35 includes a first region 37 and a second region 39 located on an outer side, in a radial direction of the workpiece 29, of the first region 37.

Similarly, on the second wafer 33, a chamfered portion 41 rounded by removal of corners of an outer peripheral portion of the second wafer 33 is formed in an annular shape along an outer periphery of the second wafer 33. The chamfered portion 41 includes a first region 43 and a second region 45 located on an outer side, in a radial direction of the workpiece 29, of the first region 43.

A specific processing method for the workpiece 29 may be similar to those in the case of the processing of the workpiece 11. As described above, the processing method according to this embodiment can also be applied in processing the workpiece 29 as the stacked wafer.

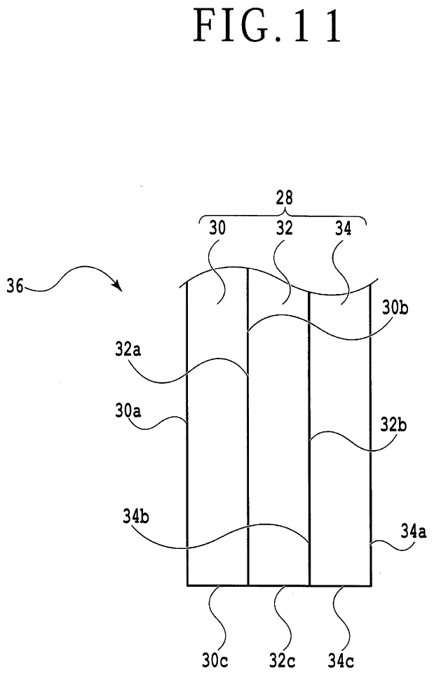

A description will next be made of a processing method according to a first modification of the above-mentioned embodiment for a workpiece. FIG. 11 is a fragmentary side view of a portion (a tip portion remote from the hub 10) of a cutting edge 28 of a cutting blade 36 to be used in the processing method according to the first modification, as seen in a direction perpendicular to its thickness direction. In this modification, a cutting machine 2 similar to that in the above-mentioned embodiment is used. However, the cutting blade 36 that has the cutting edge 28 depicted in FIG. 11 is used instead of the cutting blade 8, in this modification. The cutting edge 28 is configured with a thickness of 30 μm or greater but 5 mm or smaller, typically 3 mm.

As depicted in FIG. 11, the cutting edge 28 has a construction in which a first annular cutting edge portion 30 (hereinafter simply referred to as the “first cutting edge portion 30”), a second annular cutting edge portion 32 (hereinafter simply referred to as the “second cutting edge portion 32”), and a third annular cutting edge portion 34 (hereinafter simply referred to as the “third cutting edge portion 34”) are stacked together in the thickness direction. The first cutting edge portion 30 has a first surface 30a substantially parallel to a radial direction of the first cutting edge portion 30 and directed toward an outside of the cutting edge 28, a second surface 30b substantially parallel to the first surface 30a and directed toward an inside of the cutting edge 28, and a third surface 30c that is connected to outer peripheral edges of the first surface 30a and the second surface 30b and that constitutes a tip of the first cutting edge portion 30.

Similarly, the third cutting edge portion 34 has a first surface 34a substantially parallel to a radial direction of the third cutting edge portion 34 and directed toward the outside of the cutting edge 28, a second surface 34b substantially parallel to the first surface 34a and directed toward the inside of the cutting edge 28, and a third surface 34c that is connected to outer peripheral edges of the first surface 34a and second surface 34b and that constitutes a tip of the third cutting edge portion 34.

Also similarly, the second cutting edge portion 32 has a first surface 32a substantially parallel to a radial direction of the second cutting edge portion 32 and in contact with the second surface 30b of the first cutting edge portion 30, a second surface 32b substantially parallel to the radial direction of the second cutting edge portion 32 and in contact with the second surface 34b of the third cutting edge portion 34, and a third surface 32c that is connected to outer peripheral edges of the first surface 32a and second surface 32b and that constitutes a tip of the second cutting edge portion 32. Hence, in this modification, the second surface 30b of the first cutting edge portion 30 and the first surface 32a of the second cutting edge portion 32 are in close contact with each other, and the second surface 34b of the third cutting edge portion 34 and the second surface 32b of the second cutting edge portion 32 are in close contact with each other

Similarly to the cutting edge 12 for use in the embodiment, the first cutting edge portion 30 and the second cutting edge portion 32 have been formed, for example, by dispersing and fixing abrasive grains of diamond or the like with a binder made or resin, metal, or the like. In contrast, the third cutting edge portion 34, for example, does not contain abrasive grains, and is formed with the binder alone.

The first cutting edge portion 30 has a thickness equal to or greater than the width (the length in the radial direction) of the first region 25 such that, when allowed to cut into a workpiece 11, the first cutting edge portion 30 can cut into the entirety of the first region 25 in the radial direction of the workpiece 11.

Similarly, the second cutting edge portion 32 has a thickness equal to or greater than the width (the length in the radial direction) of the second region 27 such that, when allowed to cut into the workpiece 11, the second cutting edge portion 32 can cut into the entirety of the second region 27 in the radial direction of the workpiece 11.

It is to be noted that the thickness of the third cutting edge portion 34 can be set as desired irrespective of the thickness of the first cutting edge portion 30 and the thickness of the second cutting edge portion 32 because the third cutting edge portion 34 does not cut into the workpiece 11.

For example, the thickness of the first cutting edge portion 30 is 10 μm or greater but 3 mm or smaller, typically 1 mm. The thickness of the second cutting edge portion 32 is 10 μm or greater but 3 mm or smaller, typically 1 mm. The thickness of the third cutting edge portion 34 is 10 μm or greater but 3 mm or smaller, typically 1 mm.

The second cutting edge portion 32 is configured to be less prone to consumption than the first cutting edge portion 30. In contrast, the third cutting edge portion 34 is configured to be more prone to consumption than the first cutting edge portion 30. Hence, the second cutting edge portion 32 is least prone to consumption, and the third cutting edge portion 34 is most prone to consumption. Described specifically, such parameters as the average grain size of abrasive grains, the concentration of the abrasive grains, and the hardness of the binder are adjusted pursuant to the above-mentioned embodiment.

The processing method according to the first modification includes, as in the above-mentioned embodiment, a holding step, a position adjustment step, and a cutting step. The holding step in the processing method according to this modification is performed in a manner similar to that of the holding step S1 in the above-mentioned embodiment.

In the position adjustment step of the processing method according to the first modification, the relation in position between the cutting blade 36 of the cutting unit 4 and the workpiece 11 held on the chuck table 14 is adjusted in the first direction (the direction along the X-axis) and the second direction (the direction along the Y-axis).

Typically, the relation in position between the cutting blade 36 and the workpiece 11 is adjusted such that a lower end of the first cutting edge portion 30 of the cutting blade 36 is positioned right above the first region 25 of the chamfered portion 23 of the workpiece 11. In addition, the relation in position between the cutting blade 36 and the workpiece 11 is also adjusted such that a lower end of the second cutting edge portion 32 of the cutting blade 36 is positioned right above the second region 27 of the chamfered portion 23 of the workpiece 11.

In addition, the relation in Position between the cutting blade 36 and the workpiece 11 is adjusted such that a lower end of the third cutting edge portion 34 is positioned above a third region 47 located on an outer side, in the radial direction of the workpiece 11, of the outer peripheral portion of the workpiece 11. In other words, in order to realize such positional relations, the position in the first direction of the chuck table 14 is adjusted by the chuck table moving mechanism, and the position in the second direction of the cutting unit 4 is adjusted by the cutting unit moving mechanism.

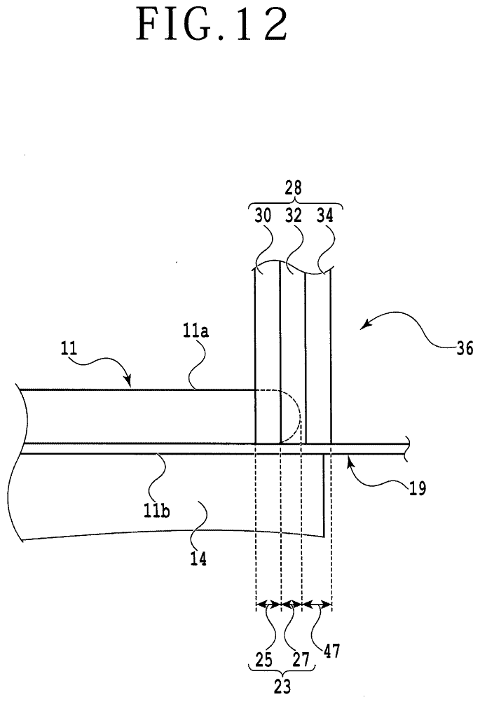

Next, the cutting step is performed. FIG. 12 is a fragmentary side view depicting the workpiece 11, the cutting edge 28, etc., in the cutting step of the processing method according to the first modification. A dashed line portion in FIG. 12 indicates the portion cut and removed by the cutting blade 36 (in other words, the chamfered portion 23 of the workpiece 11).

In the cutting step according to the first modification, operation and processing conditions for the cutting machine 2 are similar to those in the cutting step S3 according to the above-mentioned embodiment. As the cutting blade 36 and the workpiece 11 are in the positional relation adjusted in the above-mentioned position adjustment step, the third cutting edge portion 34 of the cutting blade 36 does not cut into the workpiece 11.

Because the third cutting edge portion 34 does not cut the workpiece 11 in this modification as mentioned above, the third cutting edge portion 34 does not need to contain abrasive grains, and is constituted with the binder alone. When dressing cutting edges, a cutting edge that contains abrasive grains needs longer time in work than a cutting edge that does not contain abrasive grains. This modification can shorten the time of dressing work owing to the configuration of a portion of the cutting edge 28 by the third cutting edge portion 34 that does not contain abrasive grains. In addition, the cutting edge 28 configured by the first cutting edge portion 30, second cutting edge portion 32, and third cutting edge portion 34 is enhanced as much as the increase in the overall thickness of the cutting edge 28 in the durability of the cutting blade 36 against external forces than a cutting edge configured by only the first cutting edge portion 30 and the second cutting edge portion 32. Yet, the third cutting edge portion 34 may contain abrasive grains.

Next, a description will be made of a processing method according to a second modification of the above-mentioned embodiment for a workpiece. The processing method according to the second modification includes, as in the above-mentioned embodiment and first modification, a holding step, a position adjustment step, and a cutting step. The holding step and the position adjustment step are performed in a manner similar to that of the holding step and the position adjustment step in the first modification.

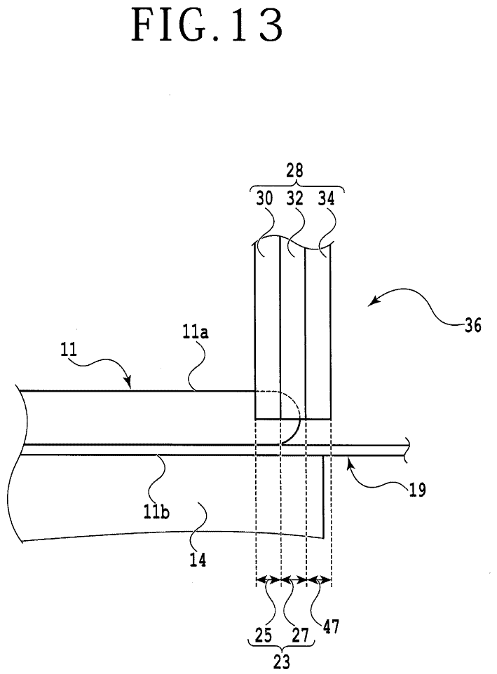

FIG. 13 is a fragmentary side view depicting the workpiece 11, the cutting edge 28, etc., in the cutting step of the processing method according to the second modification. As depicted in FIG. 13, in the cutting step of the second modification, the cutting blade 36 is allowed to cut in to a depth that does not reach a lower side, that is, the second side 11b, of the workpiece 11.

If the workpiece 11 is thinned by subsequent grinding processing, for example, it is important that the chamfered portion 23 thinned like a knife edge by the grinding processing do not remain on the outer peripheral portion of the workpiece 11. In this case, the chamfered portion 23 of the workpiece 11 needs to be removed in the cutting step to a depth corresponding to the thickness (finish thickness) of the workpiece 11 available after the grinding processing.

In such a case, the cut-in depth of the cutting blade 36 (the cut-in depth to be set on the cutting machine 2) is set, as processing conditions, to the finish thickness or greater of the workpiece 11 available after the grinding processing. The specific cut-in depth is, for example, 5 μm or greater but 80 μm or smaller, although this cut-in depth can be changed at will according to the finish thickness of the workpiece 11. It is to be noted that other processing conditions are similar to those in the above-mentioned embodiment and first modification.

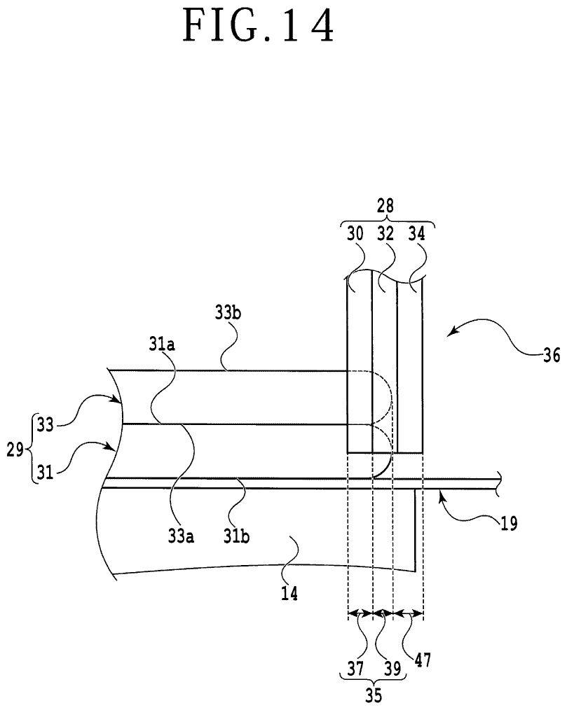

Next, a description will be made of a processing method according to a third modification of the above-mentioned embodiment for a workpiece. In this third modification, the workpiece 29 depicted in FIG. 9 is used as the workpiece. FIG. 14 is a fragmentary side view depicting the workpiece 29, the cutting edge 28, etc., in a cutting step of the processing method according to the third modification for the workpiece 29.

As depicted in FIG. 14, in the cutting step of the third modification, the workpiece 29 is processed by the cutting blade 36 used in the first modification and the second modification. Described specifically, the cutting blade 36 is allowed to cut in from the first side 33a of the second wafer 33 to a depth that does not reach a lower side, that is, the second side 31b, of the first wafer 31. As a consequence, the chamfered portion 41 (see FIG. 10) of the second wafer 33 is cut and removed in its entirety. Meanwhile, the chamfered portion 35 (see FIG. 10) of the first wafer 31 is cut and removed at only a portion thereof on a side of the second wafer 33.

According to each of the above-mentioned embodiment and respective modifications, the cutting blade 8 or the cutting blade 36 is less likely to undergo an uneven wear as described above when the outer peripheral portion (the chamfered portion 23) of the workpiece 11 or the outer peripheral portions (the chamfered portion 35 and the chamfered portion 41) of the workpiece 29 are removed by the cutting blade 8 or the cutting blade 36.

It is to be noted that the present invention can be practiced with various modifications without limitations by the descriptions of the above-mentioned embodiment and respective modifications. In the cutting step S3 according to the above-mentioned embodiment, for example, the cutting blade 8 is lowered by the cutting unit moving mechanism after being rotated by the motor. The cutting blade 8 may however be rotated by the motor after being lowered by the cutting unit moving mechanism and then being brought into contact with the workpiece 11.

Further, instead of the chuck table 14 being rotated, the cutting blade 8 may be so moved as to draw a circle along the outer periphery of the workpiece 11. Further, the chuck table 14 may be raised instead of the cutting blade 8 being lowered.

In addition, in the cutting step S3 according to the above-mentioned embodiment, the cutting blade 8 is allowed to cut in from the first side 11a of the workpiece 11 to a depth, at which the cutting blade 8 is allowed to cut slightly into the sheet 19, by continuously being lowered while being rotated together with the chuck table 14. However, the lowering of the cutting blade 8 may be performed in a plurality of steps, and the cutting of the workpiece 11 may be performed stepwise.

In this case, the cut-in depth of the cutting blade 8 in each single lowering step is set, for example, to 5 μm or greater but 300 μm or smaller, and the number of repetitions of lowering and cutting is set, for example, two times or more but 20 times or fewer.

The constructions, methods, and the like according to the above-mentioned embodiment and modifications can be practiced with changes or modifications within the scope not departing from the object of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A processing method for a disk-shaped workpiece having a first circular side and a second circular side, the processing method being applied when processing an outer peripheral portion of the workpiece and comprising:
a holding step of holding the workpiece at the second circular side thereof such that the workpiece is exposed at the first circular side thereof; and
a cutting step of, after the holding step, with an annular cutting blade including a first annular cutting edge portion and a second annular cutting edge portion that is less prone to consumption than the first annular cutting edge portion kept rotating, allowing the first annular cutting edge portion to cut into a first region of the outer peripheral portion and also allowing the second annular cutting edge portion to cut into a second region of the outer peripheral portion, the second region being located on an outer side, in a radial direction of the workpiece, of the first region, and moving the cutting blade relative to and along the outer peripheral portion of the workpiece, whereby the outer peripheral portion of the workpiece is cut.

2. The processing method according to claim 1, wherein the cutting blade further includes a third annular cutting edge portion that is more prone to consumption than the first annular cutting edge portion.

3. The processing method according to claim 2, wherein
the cutting blade has a stacked structure in which the first annular cutting edge portion, the second annular cutting edge portion, and the third annular cutting edge portion are stacked such that the second annular cutting edge portion is in contact with the first annular cutting edge portion and the third annular cutting edge portion is in contact with the second annular cutting edge portion, and,
in the cutting step, the third annular cutting edge portion is arranged in a third region located on an outer side, in the radial direction, of the outer peripheral portion.

4. The processing method according to claim 3, wherein the third annular cutting edge portion contains a binder, but not abrasive grains.

5. The processing method according to claim 1, wherein
the workpiece is a bonded wafer obtained by bonding, with a second wafer, a first wafer chamfered at an outer peripheral portion thereof, and,
in the cutting step, the cutting blade is allowed to cut into the bonded wafer from the first circular side, where the first wafer is arranged, to a position that does not reach the second circular side.

6. The processing method according to claim 2, wherein
the workpiece is a bonded wafer obtained by bonding, with a second wafer, a first wafer chamfered at an outer peripheral portion thereof, and,
in the cutting step, the cutting blade is allowed to cut into the bonded wafer from the first circular side, where the first wafer is arranged, to a position that does not reach the second circular side.

7. The processing method according to claim 3, wherein
the workpiece is a bonded wafer obtained by bonding, with a second wafer, a first wafer chamfered at an outer peripheral portion thereof, and,
in the cutting step, the cutting blade is allowed to cut into the bonded wafer from the first circular side, where the first wafer is arranged, to a position that does not reach the second circular side.

8. The processing method according to claim 4, wherein
the workpiece is a bonded wafer obtained by bonding, with a second wafer, a first wafer chamfered at an outer peripheral portion thereof, and,
in the cutting step, the cutting blade is allowed to cut into the bonded wafer from the first circular side, where the first wafer is arranged, to a position that does not reach the second circular side.

9. The processing method according to claim 1, wherein
the first annular cutting edge portion and the second annular cutting edge portion both contain abrasive grains and a binder, and
the abrasive grains contained in the second annular cutting edge portion are greater in grain size than the abrasive grains contained in the first annular cutting edge portion, the abrasive grains contained in the second annular cutting edge portion are higher in concentration than the abrasive grains contained in the first annular cutting edge portion, or the binder contained in the second annular cutting edge portion is higher in hardness than the binder contained in the first annular cutting edge portion.

10. The processing method according to claim 2, wherein
the first annular cutting edge portion and the second annular cutting edge portion both contain abrasive grains and a binder, and
the abrasive grains contained in the second annular cutting edge portion are greater in grain size than the abrasive grains contained in the first annular cutting edge portion, the abrasive grains contained in the second annular cutting edge portion are higher in concentration than the abrasive grains contained in the first annular cutting edge portion, or the binder contained in the second annular cutting edge portion is higher in hardness than the binder contained in the first annular cutting edge portion.

11. The processing method according to claim 3, wherein
the first annular cutting edge portion and the second annular cutting edge portion both contain abrasive grains and a binder, and
the abrasive grains contained in the second annular cutting edge portion are greater in grain size than the abrasive grains contained in the first annular cutting edge portion, the abrasive grains contained in the second annular cutting edge portion are higher in concentration than the abrasive grains contained in the first annular cutting edge portion, or the binder contained in the second annular cutting edge portion is higher in hardness than the binder contained in the first annular cutting edge portion.

12. The processing method according to claim 4, wherein
the first annular cutting edge portion and the second annular cutting edge portion both contain abrasive grains and a binder, and
the abrasive grains contained in the second annular cutting edge portion are greater in grain size than the abrasive grains contained in the first annular cutting edge portion, the abrasive grains contained in the second annular cutting edge portion are higher in concentration than the abrasive grains contained in the first annular cutting edge portion, or the binder contained in the second annular cutting edge portion is higher in hardness than the binder contained in the first annular cutting edge portion.
